(19) United States
(12) Patent Application Publication
(10) Pub. No.: US 2012/0050062 A1
(43) Pub. Date: Mar. 1, 2012

(54) Identifying An End Of An Electrical Cord

(75) Inventors: Matthew R. Archibald, Morrisville, NC (US); Jerrod K. Buterbaugh, Wake Forest, NC (US)

(73) Assignee: INTERNATIONAL BUSINESS MACHINES CORPORATION, Armonk, NY (US)

(21) Appl. No.: 12/862,876

(22) Filed: Aug. 25, 2010

(51) Int. Cl. G09F 9/33; G08B 5/00

(52) U.S. Cl. 340/815.45; 340/815.4

(57) ABSTRACT

An electrical cord is disclosed that includes a power line for transmitting electric current from one end of the electrical cord to the other end of the electrical cord. The electrical cord also includes a cord identification activator integrated into at least one end of the power line and coupled for data communications through the power line to a cord identification illuminator. The activator includes a signal generator for sending an indication signal to the illuminator through the power line in response to a user's activation of the activator. The illuminator illuminates in response to receiving the indication signal from the signal generator.

### BACKGROUND OF THE INVENTION

1. Field of the Invention

The field of the invention includes methods and systems for identifying an end of an electrical cord.

2. Description of Related Art

A typical data center may utilize a large number of electrical line cords to connect devices to other electrical cords or to other devices. These cords often become tangled with one another and therefore the ability of a system administrator to identify the proper end of a particular electrical cord to either connect or disconnect may be reduced. As such, system administrators are subject to accidentally disconnecting the wrong electrical line cord, thereby unnecessarily causing a power failure on a computer in the data center or unintentionally causing some other error.

### SUMMARY OF THE INVENTION

An electrical cord is disclosed that includes a power line for transmitting electric current from one end of the electrical cord to the other end of the electrical cord. The electrical cord also includes a cord identification activator integrated into at least one end of the power line and coupled for data communications through the power line to a cord identification illuminator. The activator includes a signal generator for sending an indication signal to the illuminator through the power line in response to a user's activation of the activator. The illuminator illuminates in response to receiving the indication signal from the signal generator.

An electrical cord identification system is disclosed that includes a cord identification activator that attaches to one end of a power line of an electrical cord. The electrical cord identification system also includes a cord identification illuminator that attaches to the other end of the power line. The activator includes a signal generator for sending an indication signal to the illuminator through the power line in response to a user's activation of the activator. The illuminator illuminates in response to receiving the indication signal from the signal generator.

A method of identifying an end of an electrical cord is disclosed. The method includes detecting an activation of a cord identification activator. The method also includes responsive to detecting activation of the cord identification activator, sending an indication signal from the activator to a cord identification illuminator through a power line of the electrical cord. The activator is coupled to one end of the power line and the illuminator is coupled to the other end of the power line. The method also includes receiving the indication signal at the illuminator and responsive to receiving the indication signal, illuminating the illuminator.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 illustrates an electrical cord that includes an illuminator for identifying an end of the electrical cord;

FIG. 2A illustrates an electrical cord identification system that includes an electrical cord disconnected from two cord identification interposers;

FIG. 2B illustrates an electrical cord identification system that includes an electrical cord connected to two cord identification interposers;

FIG. 3 illustrates a flow chart of a method of identifying an end of an electrical cord.

### DETAILED DESCRIPTION OF EXEMPLARY EMBODIMENTS

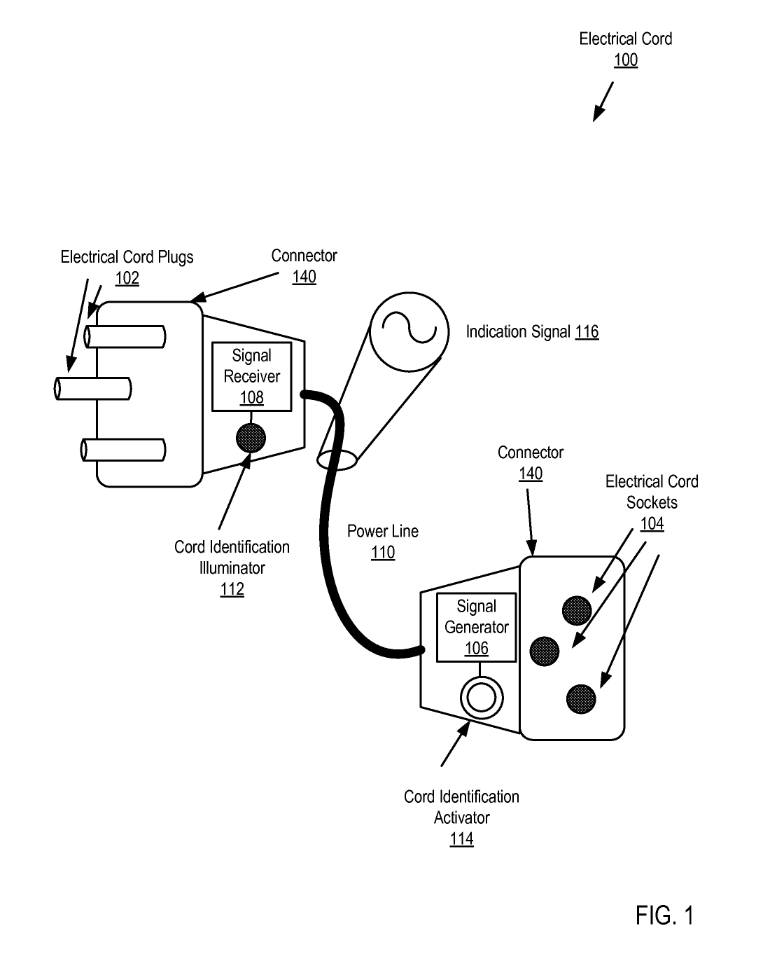

Exemplary methods and systems for identifying an end of the electrical cord in accordance with the present invention are described with reference to the accompanying drawings, beginning with FIG. 1. FIG. 1 sets forth a line drawing of an electrical cord (100) according to embodiments of the present invention. The electrical cord (100) of FIG. 1 includes a power line (110) for transmission of electrical power from one end of the electrical cord to the other end of the electrical cord. The power line (110) of FIG. 1 is a combination of electrical wires that enables electric current to flow between ends of the power line (110). The power line (110) is used to transmit an electric current to provide power from one end of the electrical cord (100) to the other end of the electrical cord (100).

At each end of the power line (110) is a connector (140) that is used to connect the electrical cord (100) to another device, cord, or power supply. At one end of the electrical cord (100) of FIG. 1, the connector (140) has electrical plugs (102) and at the other end, the connector (140) has electrical cord sockets (104). The electrical cord plugs (102) and the electrical cord sockets (104) of electrical cords according to the present invention may be any type of connectors that provide electrical connections according to embodiments of the present invention. Electrical cord plugs and their sockets differ by country in shape, size, and type of connectors. The electrical cord plugs (102) of FIG. 1 may be implemented any NEMA 1-15 plugs.

The electrical cord (100) also includes a cord identification activator (114) integrated into at least one end of the power line (110) and coupled for data communications through the power line (110) to a cord identification illuminator (112). The activator (114) and the illuminator (112) are used together to identify an end of the electrical cord (100). The illuminator (112) of FIG. 1 illuminates in response to a user activating the activator (114). The activator (114) of FIG. 1 may be implemented as a switch, button, touch screen, or any other type of interface that enables a user to register an input that will occur to those of skill in the art. The illuminator (112) of FIG. 1 may be implemented as a light source, such as a light-emitting diode (‘LED’), or any other type of device that may be used as an indicator. The illuminator (112) may flash to indicate that a user has activated the activator (114), provide a constant illumination while the activator is depressed, or any other illumination that will occur to those of skill in the art.

Activating the activator (114) results in a completion of a circuit for transmitting an indication signal (116) from the signal generator (106) to the signal receiver (108). The signal generator (106) sends the indication signal (116) through the power line (110) in response to a user's activation of the activator (114).

The signal generator (106) may also include circuitry for receiving an activation from a systems management system (not pictured). The systems management system can indicate to the signal generator (106) to provide the indication signal (116) to the signal receiver (108). For example, when the connector (140) of the power line (110) is coupled to a particular power distribution unit (PDU) that is controllable by the systems management system, an administrator can identify the power line (110) by transmitting an activation to the signal generator (106) which in response provides the indication signal (116) to the power line (110) through the particular PDU. Transmitting the indication signal (116) in response to an activation from the systems management system enables an administrator of a data center to identify an end of a power line (110) without having someone manually activate the activator (114).

The signal generator (106) transmits the indication signal (116) using a power line communication (PLC) protocol. In power line communication protocols, the power line is used to transmit data communications from one device to another. Systems operating according to such protocols operate by impressing a modulated carrier signal on the physical power line carrying the data communications. Different types of power line protocols use different frequency bands depending on the signal transmission characteristics of the power wiring used.

Examples of power line communications protocols useful in identifying the end of an electrical cord according to embodiments of the present invention include X10, KNX, INSTEON, BACnet, LonWorks, and HomePlug specifications. X10 is an international and open industry standard for communication among electrical devices used for home automation, also known as domotics. It primarily uses power line wiring for signaling and control, where the signals involve brief radio frequency bursts representing digital information. In addition, the HomePlug 1.0 specification is for connecting devices via power lines in the home.

By transmitting the indication signal (116) through the power line (110) of the electrical cord (100), a separate out of band wire dedicated to transmitting the indication signal (116) between the illuminator (112) and the activator (114) does not need to be incorporated into the electrical cord (100). Eliminating the need for a dedicated data communication wire reduces the cost and size of the electrical cord (100).

The signal receiver (108) detects the indication signal (116) transmitted through the power line (110). The signal receiver (108) of FIG. 1 operates according to power line communication (PLC) protocols discussed above.

The electrical cord (100) is not limited to a single activator (114) and a single illuminator (112). Each end of the electrical cord (100) may include at least one cord identification activator (114) and at least one cord identification illuminator (112). In such embodiments, both ends of the electrical cord (100) may be separately identified by a corresponding activator. For example, a particular illuminator (112) on one end of the power line (110) is responsive to a corresponding activator (114) on the other end of the power line (110). When more than one electrical cords are present, a first user on one end of a particular electrical cord can indicate the particular electrical cord to a second user at the end of the electrical cord. By providing the visual indication given from illuminating the illuminator (112), the users can quickly identify the particular electrical cord.

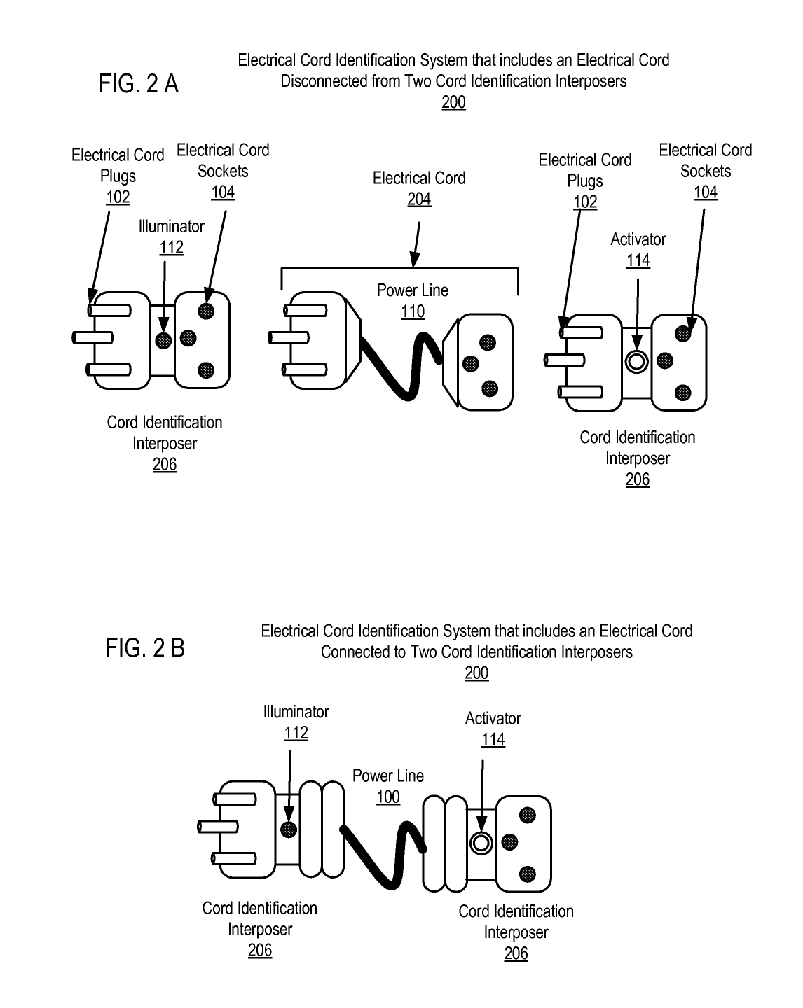

For further explanation, FIG. 2A sets forth a line drawing of an electrical cord identification system (200) according to embodiments of the present invention. In the example of FIG. 2A, the system includes an electrical cord (204) that is disconnected from two cord identification interposers (206). The electrical cord (204) of FIG. 2 may be any type of electrical cord that includes a power line (110) and at least one of an electrical cord plugs and electrical cord sockets at one end of the electrical cord. Unlike the electrical cord (100) of FIG. 1, the electrical cord (204) of FIG. 2 does not include an illuminator (112) or an activator (114), signal generator or signal receiver integrated within the electrical line cord. Instead, each end of the electrical cord (204) in FIG. 2 connects to a cord identification interposer (206) that includes an illuminator (112), an activator (114), or both. By including the illuminator (112) and activator (114) on cord identification interposers (206) instead of integrating them within the electrical cord (204), any electrical cord may be used to form the electrical cord identification system 200.

Each cord identification interposer (206) of FIG. 2A includes electrical cord plugs (102) and electrical cord sockets (104) for connecting to either the electrical cord sockets or the electrical cord plugs of the electrical cord (204). The electrical cord sockets (104) of the cord identification interposer (206) of FIG. 2 A connect with the electrical cord plugs of the electrical cord (204) and the electrical cord plugs (102) of the cord identification interposer (206) connect with the electrical cord sockets of the electrical cord (204).

The electrical cord interposers (206) of FIG. 2A form a paired system. In this case, at least one of the interposers (206) includes a cord identification activator (114) that attaches to one end of the power line (110) of the electrical cord (204) and the interposer (206) of the pair that includes a cord identification illuminator (112) attaches to the other end of the power line (110). Alternatively, each cord identification interposer (206) may include both an illuminator (112) and an activator (114).

For further explanation, FIG. 2B sets forth a line drawing of the system of FIG. 2A after connecting the electrical cord (204) with the two cord identification interposers (206).

In an alternative to a completely embedded cord identification system, as illustrated in FIG. 1, or a cord identification system that uses two interposers, as illustrated in FIGS. 2A and 2B, a hybrid cord identification system that includes an embedded illuminator and a cord identification interposer may be used to identify an end to an electrical cord. For example, an electrical cord may include an embedded illuminator at one of the electrical cord, where the electrical cord does not have an embedded activator at either end. In this case, a cord identification interposer (206) that includes an activator may be attached to the electrical cord. After being attached to the electrical cord, the activator (114) on the cord identification interposer (206) may be activated and an indicator signal may be sent to the embedded illuminator at the other end of the electrical cord. The advantage to this system is that after identifying the particular electrical cord, the cord identification interposer (206) may be attached to another electrical cord that includes an embedded illuminator. As such, one cord identification interposer (206) may be used to identify ends of a group of electrical cords, thus reducing hardware costs associated with multiple activators while maintaining the simplicity of reconnecting only the cord identification interposer with the activator. In a similar embodiment of the hybrid cord identification system, an electrical cord with an embedded activator is used with a cord identification interposer (206) that includes an illuminator (112). In this case, one illuminator may be interchangeably paired with multiple activators, each of which is embedded in a different electrical cord.

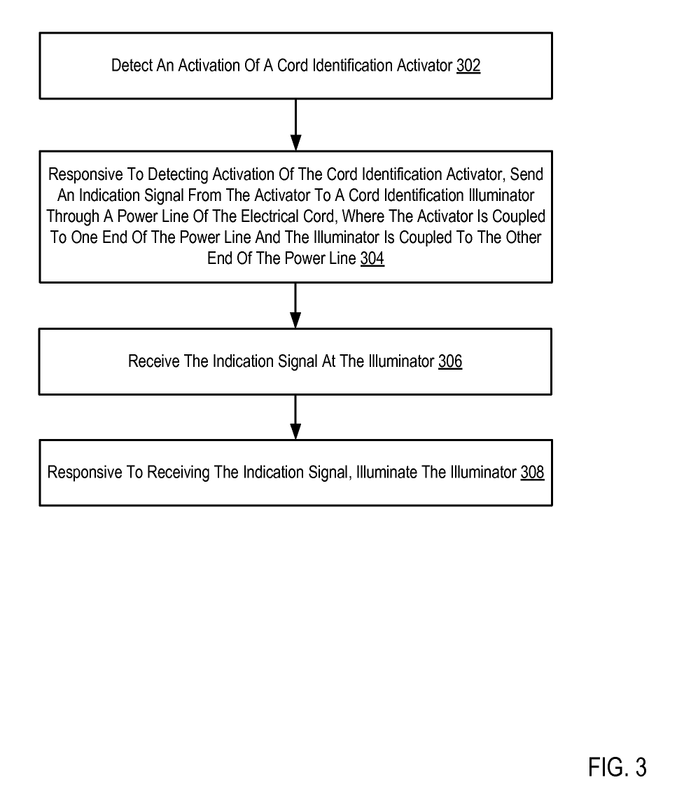

For further explanation, FIG. 3 sets forth a flow chart illustrating an exemplary method for identifying an end of an electrical cord according to embodiments the present invention. The method of FIG. 3 may be used in conjunction with the electrical cord (100) of FIG. 1, the electrical cord identification system (200, 202) of FIGS. 2A and 2B, or the hybrid cord identification system described above.

The method of FIG. 3 includes detecting (302) an activation of a cord identification activator. Detecting (302) an activation of a cord identification activator may be carried out by the activator (114) either integrated into the electrical cord (100) of FIG. 1 or in an interposer (206) of FIGS. 2A and 2B.

The method of FIG. 3 also includes responsive to detecting activation of the cord identification activator, sending (304) an indication signal from the activator to a cord identification illuminator through a power line of the electrical cord, wherein the activator is coupled to one end of the power line and the illuminator is coupled to the other end of the power line. Sending (304) an indication signal from the activator to a cord identification illuminator through a power line of the electrical cord may be carried out according to a power line protocol such as X10 or any other protocol that will occur to those of skill in the art.

The method of FIG. 3 includes receiving (306) the indication signal at the illuminator. Receiving (306) the indication signal at the illuminator may include the signal receiver (108) of FIG. 1 receiving the indication signal (116) through the power line (110).

The method of FIG. 3 includes responsive to receiving the indication signal, illuminating (308) the illuminator. Illuminating (308) the illuminator may be carried out by the illuminator (112) of FIG. 1 flashing to indicate that the activator (114) has been activated.

The flowchart and block diagrams in the Figures illustrate the architecture, functionality, and operation of possible implementations of systems and methods according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. An electrical cord, comprising:
a power line for transmitting electric current from one end of the electrical cord to the other end of the electrical cord;
a cord identification activator integrated into at least one end of the power line and coupled for data communications through the power line to a cord identification illuminator; and
a signal generator for sending an indication signal to the illuminator through the power line in response to a user's activation of the activator and the illuminator illuminating in response to receiving the indication signal from the signal generator.

2. The electrical cord of claim 1, wherein each end of the electrical cord includes at least one cord identification activator and at least one cord identification illuminator, wherein a particular illuminator on one end of the power line is responsive to a corresponding activator on the other end of the power line.

3. The electrical cord of claim 1 further comprising a signal receiver that detects the indication signal transmitted through the power line.

4. The electrical cord of claim 3, wherein the signal receiver uses a power line communication (PLC) protocol to detect the indication signal.

5. The electrical cord of claim 1, wherein the illuminator flashes in response to receiving the indication signal.

6. The electrical cord of claim 1, wherein the activator includes a button.

7. The electrical cord of claim 1, wherein the illuminator includes an LED.

8. An electrical cord identification system, comprising:
at least one cord identification interposer that includes a cord identification activator that attaches to one end of a power line of an electrical cord; and
at least one cord identification interposer that includes a cord identification illuminator that attaches to the other end of the power line;
the cord identification interposer with the activator sending an indication signal to the illuminator through the power line in response to a user's activation of the activator and the illuminator illuminating in response to receiving the indication signal.

9. The electrical cord identification system of claim 8, wherein one cord identification interposer attaches to sockets of the power line and the other cord identification interposer attaches to plugs of the power line.

10. The electrical cord identification system of claim 8, wherein the cord identification illuminator includes a signal receiver that detects the indication signal transmitted through the power line.

11. The electrical cord identification system of claim 10, wherein the signal receiver uses a power line communication (PLC) protocol to detect the indication signal.

12. The electrical cord identification system of claim 8, wherein the illuminator flashes in response to receiving the indication signal.

13. The electrical cord identification system of claim 8, wherein the activator includes a button.

14. The electrical cord identification system of claim 8, wherein the illuminator includes an LED.

15. A method of identifying an end of an electrical cord, comprising:
detecting an activation of a cord identification activator;
responsive to detecting activation of the cord identification activator, sending an indication signal from the activator to a cord identification illuminator through a power line of the electrical cord, wherein the activator is coupled to one end of the power line and the illuminator is coupled to the other end of the power line; and
receiving the indication signal at the illuminator; and
responsive to receiving the indication signal, illuminating the illuminator.

16. The method of claim 16, further comprising detecting the indication signal transmitted through the power line.

17. The method of claim 18, wherein a power line communication (PLC) protocol is used to detect the indication signal.

18. The method of claim 16, wherein the illuminator includes an LED.
